(19) United States
(12) Patent Application Publication
(10) Pub. No.: US 2025/0004813 A1
(43) Pub. Date: Jan. 2, 2025

(54) SYSTEM AND METHOD FOR AGENT- LESS SCANNING OF CLOUD INFRASTRUCTURE

(71) Applicant: COLORTOKENS INC., SANTA CLARA, CA (US)

(72) Inventor: RAVI PATTABHI, Acton, MA (US)

(21) Appl. No.: 18/344,277

(22) Filed: Jun. 29, 2023

(51) Int. Cl. G06F 9/455

(52) U.S. Cl. CPC G06F 9/45558; G06F 2009/45562; G06F 2009/45587; G06F 2009/45591

(57) ABSTRACT

A method and a system of an agent-less scanning of cloud infrastructure is disclosed. The method includes running a virtual machine (VM) from a customer account and creating a snapshot of the VM in the customer account and saving the snap-shot of the virtual machine into a storage account. The method further includes creating at least one of: a docker image, a VM instance and a bare-metal system by restoring the respective snapshot saved in the storage account and gaining access to a restored system. The method further includes scanning the restored system by one of: using an ephemeral scanner that runs during a boot time of an instance or using a docker based command on a launched container and terminating instances of an ephemeral scanner by sending a message to at least one of: a cloud and a plurality of cloud servers for terminating the instances.

### BACKGROUND

### Technical Field

The embodiments herein generally relate to a field of scanning systems. More particularly, the embodiments herein relates to a method and a system for on agent-less scanning of cloud infrastructure.

### Description of the Related Art

Traditionally scanning of on-premises and cloud infrastructure software for misconfigurations, vulnerabilities and malware is performed using an agent-based scanner or remote scanner using a remote agent that is connected to systems to run scans remotely. Agent based scanners require an end user to install and upgrade them. Agent based scanners are typically run on the customer systems to use up resources on the production systems which in turn might disrupt application or perturb their performance. The agents are run on the customer systems, provided on isolated networks and the agents cannot send their results back to central servers so the reports can be viewed. The agents themselves can be vectors for remote vulnerability attacks and can be used to hack into production systems. Since cloud systems can be launched at any time with a simple application programming interface call, it is not always possible to install an agent into all the launched systems. It is possible to create images with agents that are already present in the image but there is a matter of ensuring that all launched systems use the correct image and also the maintenance cost of keeping these images for all the flavors of systems which need to be managed.

Remote scanning requires some type of credential for remote connections to the system being scanned and is typically achieved by using remote protocols. These credentials have to be rotated and fed into remote scanners. These remote credentials that can be stolen or leaked and can pose a risk to production systems. Similar to agent-based scanning, the remote scanning involves a remote scan agent as well and the remote scan agent also needs to be installed, configured with credentials and upgraded over time. Additionally, ad hoc systems launched via cloud application programming interfaces (APIs) cannot be easily scanned because they are ephemeral in nature and the remote scanners will not know of their existence. The huge drawback in both the cases, is the know how necessary for an end user to install, configure and maintain systems. Moreover, there is a lack of cybersecurity expertise at present and most companies do not have security operations team that has enough people with cybersecurity knowledge to install and maintain scanners that are local or remote which can scan for misconfigurations, vulnerabilities or malware.

The above-mentioned shortcomings, disadvantages and problems are addressed herein, and which will be understood by reading and studying the following specification.

### OBJECTS OF THE INVENTION

The primary object of the embodiments herein is to provide a system and method for agent-less scanning of the cloud infrastructure.

Another object of the embodiments herein is to provide the system that is able to run the scans from backups while the system is restored using the “cloud-init” functionality exposed by cloud vendors and wherein “Cloud init” is an open source framework and it is mearly a hook into running some code during the boot time of a virtual machine (VM)

Yet another object of the embodiments herein is to provide an agent less scanning system and methos that are supported across AWS, Azure and GCP on various Linux and windows platforms.

Yet another object of the embodiments herein is to provide agent-less scans that are run during boot time after restoring a snapshot, and are supported across all flavors of Linux and windows.

Yet another object of the embodiments herein is to provide the system that uses cloud resource orchestration tooling to automatically send an authorization descriptor and resource orchestration status messages to another user.

Yet another object of the embodiments herein is to provide agent-less scans of operating system (OS) misconfigurations which require operating system (OS) kernel to be loaded so the runtime system is analyzed.

These and other objects and advantages will become more apparent when reference is made to the following description and accompanying drawings.

### SUMMARY

This summary is provided to introduce a selection of concepts in a simplified form that are further disclosed in the detailed description. This summary is not intended to determine the scope of the claimed subject matter.

The present invention aims to address the drawbacks of agent based and remote scanners by accomplishing the same scanning for misconfigurations, malware and vulnerabilities using an agent-less scanner. An agent-less scanner does not require the customer to install any agents. It uses the backups of the systems to be scanned to perform scans on a shadow copy of these systems and thereby eliminates many of the aforementioned drawbacks in the existing techniques.

In an aspect, a method of an agent-less scanning of cloud infrastructure is provided. The method includes running a virtual machine (VM) from a customer account and creating a snapshot of the VM in the customer account and saving the snapshot of the virtual machine into a storage account. The method further includes creating at least one of: a docker image, a virtual machine instance and a bare-metal system by restoring the respective snapshot saved in the storage account and gaining access to a restored system. The method further includes scanning the restored system by one of: using an ephemeral scanner that runs during a boot time of an instance or using a docker based command on a launched container.

According to an embodiment, the method further includes terminating instances of an ephemeral scanner by sending a message to at least one of: a cloud and a plurality of cloud servers for terminating the instances.

According to an embodiment, the method further includes leveraging a cloud init functionality exposed by a plurality of cloud vendors to run an agent-less scanning during the boot time of an instance, in a Linux based system.

According to an embodiment, the method further includes obtaining a new snapshot to get the latest state of the system scanned during the scan runs.

According to an embodiment, the cloud-init functionality allows the scanner to run at boot time with elevated privileges which allows to perform at least one of: misconfiguration or compliance checks at an operating system (OS) level.

According to an embodiment, the process of scanning the system in windows includes preparing windows system by performing the following steps of including launching a windows snapshot of a source system to be scanned; detaching a boot volume of the source system and launching a temporary Linux instance with a secure shell (ssh) access enabled; attaching the boot volume of the source system to the temporary Linux system; starting the temporary Linux system and mounting the windows disk on the temporary Linux system using cloud init; booting up the windows machines; running the scanner during windows startup and receiving the functionality comprising the misconfiguration and compliance checks at an operating system (OS) level.

According to an embodiment, the step of launching windows snapshot of source system to be scanned and detaching the boot volume further includes launching the windows snapshot, shutting down the instance after the window snapshot is launched and detaching a disk from the system.

According to an embodiment, starting temporary Linux system and using cloud init to mount the windows disk further includes installing a new technology file system (ntfs) driver on the linux system, installing a chntpw utility, mounting ntfs volume, injecting a windows service to start on the next launch of the windows instance using a reged command and installing a required service binary on the windows disk and configuring a service binary to start the scanner when windows starts up and unmounting the volume.

According to an embodiment, the step of scanning of the docker image further includes launching a docker image and running the scan operations using docker command which performs the scan tasks for at least one of: operating system (OS) misconfigurations, software vulnerabilities and malware and ransomware scan.

According to an embodiment, a system of agent-less scanning of cloud infrastructure is provided. The system includes a memory for storing one or more executable modules and a processor for executing the one or more executable modules for agent-less scanning. The one or more executable modules includes a running module, creation module, scan module and termination module. A running module is configured for running a virtual machine (VM) from a customer account and creating a snapshot of the VM in the customer account and saving the snapshot of the virtual machine into a storage account. A creation module is configured for creating at least one of: a docker image, a VM instance and a bare-metal system by restoring the respective snapshot saved in the storage account and gaining access to a restored system. A scan module is configured for scanning the restored system by using an ephemeral scanner that runs during a boot time of an instance or using a docker based command on a launched container. A termination module is configured for terminating instances of an ephemeral scanner by sending a message to at least one of: a cloud and a plurality of cloud servers for terminating the instances.

According to an embodiment, the scan module is further configured for leveraging a cloud init functionality exposed by a plurality of cloud vendors to run an agent-less scanning during the boot time of an instance.

According to an embodiment, the scan module is further configured for obtaining a new snapshot to get the latest state of the system scanned during the scan runs.

According to an embodiment, the cloud-init functionality allows the scanner to run at boot time with elevated privileges which allows to perform misconfiguration or compliance checks at an operating system (OS) level.

According to an embodiment, the scan module is further configured for preparing windows system by performing the steps that includes launching a windows snapshot of a source system to be scanned and detaching a boot volume of the source system and launching a temporary linux instance with a secure shell (ssh) access enabled. The scan module further includes attaching the boot volume of the source system to the temporary linux system. The scan module further includes starting the temporary linux system and mounting the windows disk on the temporary linux system using cloud init and booting up the windows machines and running the scanner during windows startup and receiving the functionality comprising the misconfiguration and compliance checks at an operating system (OS) level.

According to an embodiment, the scan module is further configured for launching the windows snapshot, shutting down the instance after the window snapshot is launched and detaching a disk from the system.

According to an embodiment, the scan module is further configured for installing a new technology file system (ntfs) driver on the linux system, installing a chntpw utility, mounting a new technology file system (ntfs) volume, injecting a windows service to start on the next launch of the windows instance using a reged command and installing a required service binary on the windows disk and configuring a service binary to start the scanner when windows starts up and unmounting the volume.

According to an embodiment, the creation module is further configured for launching a docker image and running the scan operations using docker command which performs the scan tasks for at least one of: operating system (OS) misconfigurations, software vulnerabilities and malware and ransomware scan.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for agent-less scanning for cloud infrastructure, in accordance with an embodiment herein.

FIG. 2 depicts a functional block diagram of an agent-less cloud scanner design of windows azure flow, in accordance with an embodiment;

FIGS. 3A-3B illustrate a process flow diagram depicting a method of agent-less scanning of a cloud infrastructure for linux and windows-based systems, in accordance with an embodiment herein;

FIG. 4 illustrates a flowchart of a method of agent-less scanning of the cloud infrastructure, in accordance with an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE DRAWINGS

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The embodiments herein provide a system and method for agent-less scanning of cloud infrastructure. The present technology uses snapshots or disk level backups of virtual machines or docker images to perform agent-less scans. Typically, the backups can be restored but fails to have access to the systems since a scanner lacks the credentials to access the restored backup. The present technology provides an approach to circumvent the above issues with existing solutions. In the present technology, a docker image or a virtual machine (VM) instance or a bare-meta system is scanned by restoring their respective backup/image and gaining access to the restored systems and once access is gained it is possible to then scan the system using a scanner that runs during the boot time of these instances or using docker based commands on the launched container. According to an embodiment, the scanner used includes, an ephemeral scanner, a cloud scanner and a standalone scanner and the like. The cloud scanner is launched with cloud init or by binding agent to boot sequence. The docker scanning is also launched by binding scanner using cloud init to launch on the boot of a linux VM. In the present technology, the scanner is installed in the conventional way, however when the scanner is run, the scanner is passed in the docker image that needs to be pulled and scanned from the container repository. According to one embodiment herein, the present technology uses a snapshot/backup copy of an instance and to restore the snapshot to create a running instance. However, during restore the “cloud init” functionality exposed is leveraged by all the cloud vendors to run the agent-less scanner during the boot time of an instance. The same approach is applicable during scanning a snapshot or if we have a running instance for which a new snapshot is taken. Every time the scan runs we can take a new snapshot to get the latest state of the system scanned.

The cloud init functionality allows the scanner to run at boot time with elevated privileges which allows us to do all the misconfiguration/compliance checks at the OS level. The cloud init is an open-source framework and is a hook into running some code during the boot time of a virtual machine (VM). The cloud vendors support cloud init as a means for end user to override the boot sequence. The scanner is injected into the boot sequence using cloud init. This is nothing more than installing the scanner tool and invoking it in a script and the script is bound into cloud init to be executed during boot. Further performing this sequence during boot allows us to override additional things that is not interfered with the scans such as launch of unnecessary services, mount of additional data volume which is not required to scan.

During the cloud scan, the instance is placed and launched into a sand box that is a custom virtual private cloud (VPC) and subnet with a security group (or firewall) which will prevent all inbound access and even outbound access is limited to only the own xcloud cloud service. This ensures that the launched shadow instance does not connect to any end customer services that are accessible on the public internet. This is necessary to ensure that the scans do not interfere with any production services. The present invention also can assess all the software installed for any known vulnerabilities. The disk files can be scanned for any malware or ransomware as well. The present technology uses a lightweight scanner that performs all these tasks in a matter of 2-5 minutes, and these are completed and the results are uploaded within the boot cycle itself. The light-weight scanner is a scanner that can run on 1vcpu and 1 gigabyte (GB) of memory within a minute and half. The install size itself is only 25 megabytes (MB) or so and the scanner can perform compliance check, scan for malware, scan for secrets and also collect operating system (OS) information all within a short time, like a minute and half.

Several existing vendors have agents that are many GB in size and also do not even run in boxes as small as in the present technology. For instance, center for internet security (CIS) agent will require a medium sized box of 4 GB and 2 CPUs to run and the same with the other agents. The same approach also works well in the case of docker images, where the docker image is launched and runs the scan operations using docker command which perform all the same scan tasks for OS misconfigurations, software vulnerabilities and malware and ransomware scan. The above approach works well for all Linux flavors supported by cloud vendors. For windows however, the cloud-init does not work in Amazon web services (AWS), Azure or google cloud platform (GCP). In such case, in the system of the present technology, an alternative mechanism is used to achieve the same functionally of running the scan during the boot time of a cloud system from its snapshot.

In some embodiments, in the present technology, in the case of windows, the following procedure is employed to scan the system:
1. Prepare windows system by doing these parallel steps:
a) Launch Windows snapshot of source system to be scanned and detach its boot volume
i. Launch the windows snapshot.
ii. Shutdown the instance as soon as it launches.
iii. Detach the disk from the system.
b) Launch temporary linux instance with ssh access enabled.
2. Once 1a and 1b complete attach the windows boot volume to the temporary linux system
3. Start temporary linux system and using cloud init mount the windows disk on it.
a. Install ntfs driver on the linux system.
b. Install the chntpw utility.
c. Mount the ntfs volume.
d. Use the reged command to inject a windows service to start on the next launch of the windows instance.
e. Install the necessary service binary on the windows disk and configure it so it starts the scanner when windows start up
f. Unmount volume.
4. Boot up the windows machines. At this point the scanner will run during windows startup and get the same functionality as on linux.

The NTFS driver is an open-source driver available for linux. After installing the package for NTFS drive, the NTFS driver is used to mount the storage volumes file system. In both windows and linux the NTFS driver runs on boot functionality either via cloud init or using the windows method described above can also be used to self-terminate the instance. Once the scan is completed the scanner sends a message to the cloud to let the cloud servers know that the instance can be terminated, and the cloud servers then terminate the instance immediately. This ensures that the scan system runs for as long as necessary, minimizing any costs for performing the scan.

According to an embodiment, the scan procedure remains common irrespective of operating system (OS). The scanner is installed and runs the scanner. The procedure to secure the virtual machine (VM) with a firewall and set up a virtual private cloud (VPC) to protect it is all the same. In linux the procedure is done using cloud init. There are slight variances on windows across AWS, GCP and Azure. In AWS, the procedure is to modify boot volume with ntfs driver and inject scanner. In Azure, the procedure is to create a custom script extension and bind it to the boot sequence. For google cloud platform (GCP) the same approach as AWS is used.

In an embodiment, a system of an agent-less scanning of cloud infrastructure comprises:
a memory for storing one or more executable modules; and
a processor for executing the one or more executable modules for agent-less scanning, the one or more executable modules comprising:
a running module for running a virtual machine (VM) from a customer account and creating a snapshot of the VM in the customer account and saving the snapshot of the virtual machine into a storage account.
a creation module for creating at least one of: a docker image, a virtual machine instance and a bare-metal system by restoring the respective snapshot saved in the storage account and gaining access to a restored system.
a scan module for scanning the restored system by one of: using an ephemeral scanner that runs during a boot time of an instance or using a docker based command on a launched container; and
a termination module for terminating instances of an ephemeral scanner by sending a message to at least one of: a cloud and a plurality of cloud servers for terminating the instances.

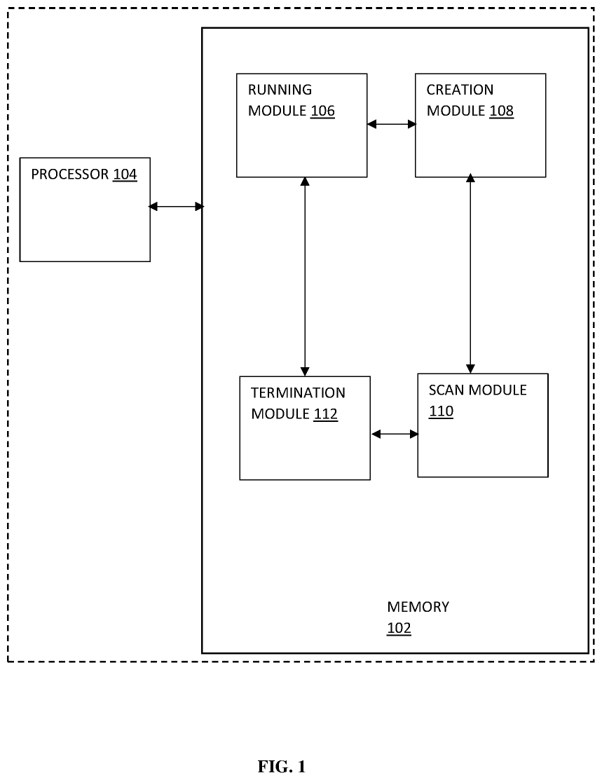

FIG. 1 depicts a system 100 diagram for an agent-less scanning of the cloud infrastructure, in accordance with an embodiment. System 100 comprises a memory 102 for storing one or more executable modules and a processor 104 for executing the one or more executable modules for agent-less scanning. The one or more executable modules comprises a running module 106, a creation module 108, a scan module 110 and a termination module 112. The running module 106 is configured for running a virtual machine (VM) from a customer account and creating a snapshot of the VM in the customer account and saving the snapshot of the virtual machine into a storage account. The creation module 108 is configured for creating at least one of: a docker image, a virtual machine (VM) instance and a bare-metal system by restoring the respective snapshot saved in the storage account and gaining access to a restored system.

The scan module 110 is configured for scanning the restored system by one of: using an ephemeral scanner that runs during a boot time of an instance or using a docker based command on a launched container. The termination module 112 is configured for terminating instances of an ephemeral scanner by sending a message to at least one of: a cloud and a plurality of cloud servers for terminating the instances. The scan module 110 is further configured for leveraging a cloud init functionality exposed by a plurality of cloud vendors to run an agent-less scanning during the boot time of an instance. The scan module 110 is further configured for obtaining a new snapshot to get the latest state of the system scanned during the scan runs. The cloud-init functionality allows the scanner to run at boot time with elevated privileges which allows it to perform at least one of: misconfiguration or compliance checks at an operating system (OS) level. The scan module 110 is further configured for preparing windows system by performing the steps comprising launching a windows snapshot of a source system to be scanned and detaching a boot volume of the source system and launching a temporary linux instance with a secure shell (ssh) access enabled.

The scan module 110 is further configured for attaching the boot volume of the source system to the temporary linux system, starting the temporary linux system and mounting the windows disk on the temporary linux system using cloud init and booting up the windows machines and running the scanner during windows startup and receiving the functionality comprising the misconfiguration and compliance checks at an operating system (OS) level. The scan module 110 is further configured for launching the windows snapshot, shutting down the instance after the window snapshot is launched and detaching a disk from the system. The scan module 110 is further configured for installing a new technology file system (ntfs) driver on the linux system, installing a chntpw utility, mounting a new technology file system (ntfs) volume, injecting a windows service to start on the next launch of the windows instance using a reged command and installing a required service binary on the windows disk and configuring a service binary to start the scanner when windows starts up and unmounting the volume. The creation module 108 is further configured for launching a docker image and running the scan operations using docker command which performs the scan tasks for at least one of: operating system (OS) misconfigurations, software vulnerabilities and malware and ransomware scan.

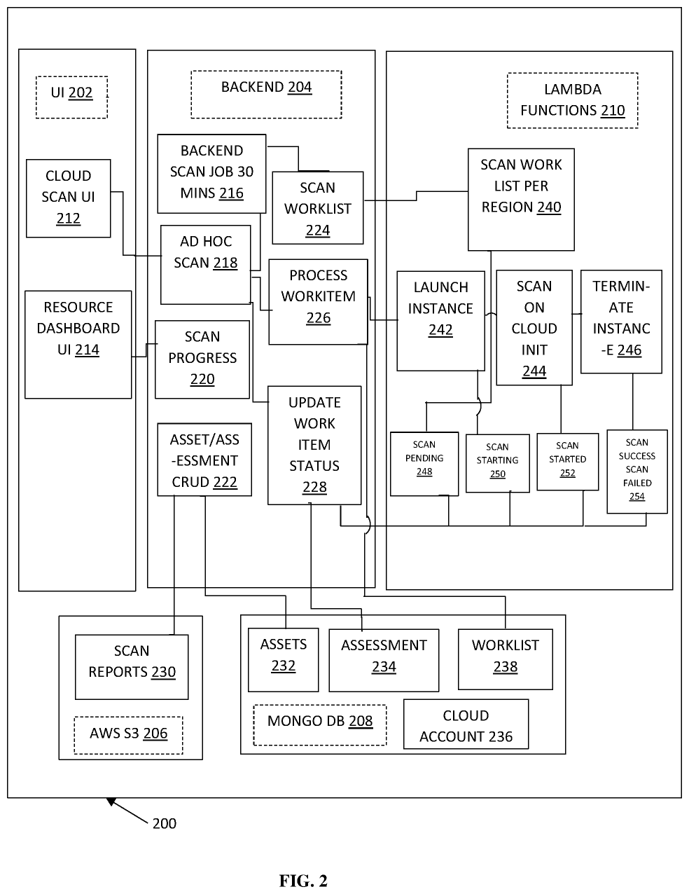

FIG. 2 depicts a block flow diagram of an agent-less cloud scanner design of windows azure flow, in accordance with an embodiment. The scanner comprises UI 202, backend 204 where the backend part comprises AWS S3 206 and MongoDB 208, lambda functions 210. There are certain operations performed in each part. The UI 202 part comprises cloud scan UI 212 and resource dashboard UI 214. The cloud scan UI 212 is communicated with the ad hoc scan 218 in the backend 204 part. The resource dashboard UI 214 is communicated with the scan progress 220 in the backend 204 part. The backend 204 part comprises operations of scanning backend job 216 which takes 30 mins to get completed. After this process the worklist is scanned 224 and the status of work item is updated 228. After the ad hoc scan 218 the processing of work item starts 226 which provides the worklist 238 in mongoDB 208. The backend 204 performs asset/assessment CRUD 222 and it provides scan reports 230 in AWS S3 206 and assets 232 and assessments 234 in the mongoDB 208. The mongoDB 208 also comprises a cloud account 236. The scanned worklist in backend 204 is sent to lambda functions 210. Here the worklist is scanned as per region 240. If the scan is pending 248 the lamba functions 210 launches the instance 242 by using the processed work item 226 in backend 204. The scan starts 250 during the time. Next it is scanned on cloud init 244, and the scanning starts 252. The last step is to terminate instance 246. Here it shows if the scan is successful or failed 254. These statuses of scanning are communicated with the process of updating work item status 228 in the backend 204.

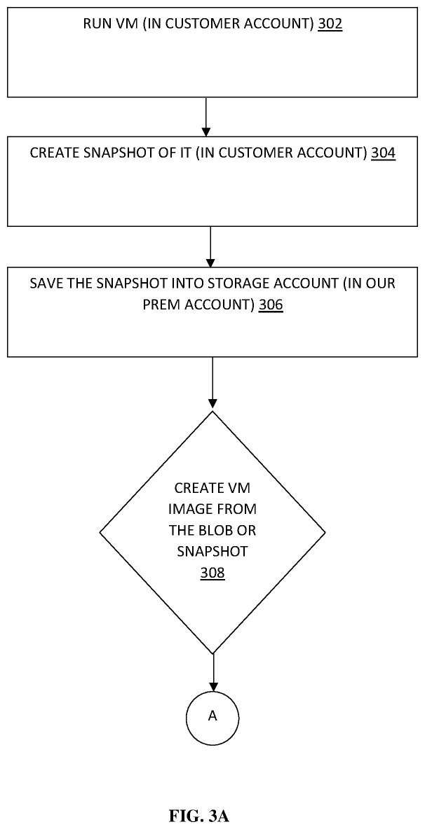

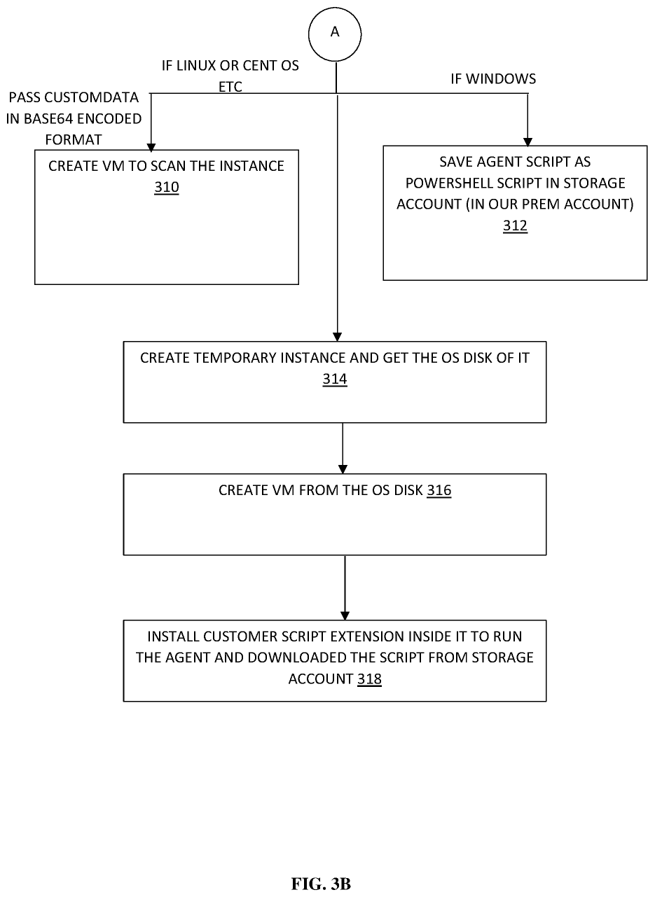

FIGS. 3A-3B illustrate a process flow diagram depicting a method of agent-less scanning of a cloud infrastructure for linux and windows-based systems, in accordance with an embodiment herein. At step 302, a virtual machine (VM) is run in the customer account. At step 304, a snapshot of the VM is created in a customer account. At step 306, the snapshot is saved in the storage account. At step 308, virtual machine (VM) image is created from the blob or snapshot. At step 310, a virtual machine (VM) is created to scan the instance in case of linux system or centos, etc. The custom data is passed using base64 encoded format. At step 312, the agent script is saved as power script in the storage account in case of the windows system. At step 314, a temporary instance is created, and an operating system (OS) disk is obtained out of it. At step 316, virtual machine (VM) is created from the OS disk. At 318, the custom script extension is installed in it to run the agent and downloaded the script from the storage account.

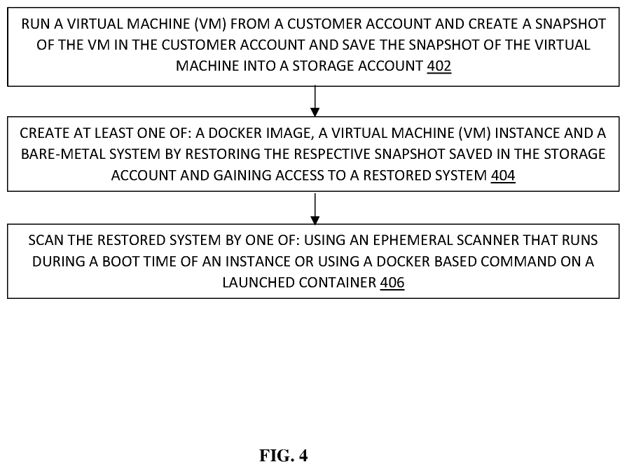

FIG. 4 depicts a flowchart of a method of agent-less scanning of the cloud infrastructure, in accordance with an embodiment. At step 402, a virtual machine (VM) is run from a customer account and a snapshot of the virtual machine (VM) is created in the customer account and the snapshot of the virtual machine is saved into a storage account. At step 404, at least one of: a docker image, a virtual machine (VM) instance and a bare-metal system is created by restoring the respective snapshot saved in the storage account and gaining access to a restored system. At step 406, the restored system is scanned by one of: using an ephemeral scanner that runs during a boot time of an instance or using a docker based command on a launched container. Subsequently the instances of an ephemeral scanner are terminated by sending a message to at least one of: a cloud and a plurality of cloud servers for terminating the instances.

The various embodiments of the present technology enable running the scans from backups while the system is being restored using the cloud-init functionality exposed by cloud vendors. The present technology also supports this across AWS, Azure and GCP on various linux and windows platform. The solution is very portable to all other cloud vendors and OS as well. The present technology provides agent-less scans that run during boot time after restoring a snapshot, it supports across all flavors of linux and windows. The present technology supports AWS, Azure and GCP and portability of the solution to other cloud vendors. The system supports scanning both VM instances and docker images. The system uses cloud resource orchestration tooling to automatically send an authorization descriptor and resource orchestration status messages to another user. In terms of alternative methods for agent-less cloud scans agent can be installed in one machine and scan VMs remotely but this requires running processes on the production systems which is not exactly the same as agent-less. In some embodiments, the present technology can scan boot volume for malware or vulnerabilities without the need to scan the OS.

The embodiments herein provide a system and method for agent-less scanning using storage snapshots of virtual machine (VM) instances or docker images that don't require credentials to scanned systems or install of agents. The present invention also provides agent-less scans of OS misconfigurations which require OS kernel to be loaded so runtime system can be analyzed. The best alternative is what some of the competitors Orca and Wiz are doing, which is to perform agentless scans by restoring the instance volume and scanning the systems by looking at the disk images. However, in this case the OS runtime cannot be scanned as the OS kernel is not running. In the approach taken in this invention it's able to bring up the OS and scan it for both misconfiguration, software vulnerabilities, supply chain vulnerabilities of custom applications, ransomware, or malware. It is expected to make additional improvements to add support for scanning more types of cloud systems besides OS. The current implementation is supported by AWS, Azure and GCP, however the same approach will work for other clouds including Oracle cloud, Alibaba. It will also work in private cloud like VMWare. It is expected to expand the service to support the other clouds. The present invention allows a SaaS security service to continuously scan cloud systems autonomously wherein they can be continuously assessed for vulnerabilities, misconfigurations and malware/ransomware. There is no additional configuration needed from customers such as the hostnames/ip addresses/ports/credentials or any requirement to install anything on the systems being scanned. The present invention is applicable mostly to Software as a Service (SaaS) firms that are geared towards the management of the security posture of cloud instances and docker images.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A method of an agent-less scanning of cloud infrastructure, the method comprises:
running a virtual machine (VM) from a customer account and creating a snapshot of the VM in the customer account and saving the snapshot of the virtual machine into a storage account;
creating at least one of: a docker image, a VM instance and a bare-metal system, by restoring the snapshot saved in the storage account and gaining access to a restored system; and
scanning the restored system by one of: using an ephemeral scanner that runs during a boot time of an instance or using a docker based command on a launched container.

2. The method of claim 1, further comprises terminating one or more instances of the ephemeral scanner by sending a message to at least one of: a cloud and a plurality of cloud servers for terminating the instances.

3. The method of claim 1, wherein the method further comprises leveraging a cloud init functionality exposed by a plurality of cloud vendors to run an agent-less scanning during the boot time of an instance, in a linux based system.

4. The method of claim 3, further comprises obtaining a new snapshot to get the latest state of the system scanned during the scan runs.

5. The method of claim 3, wherein the cloud-init functionality allows the scanner to run at boot time with elevated privileges which allows performing at least one of: a misconfiguration check or a compliance check at an operating system (OS) level.

6. The method of claim 1, wherein scanning the system in windows comprises:
preparing a windows system by performing the steps comprising:
a) launching a windows snapshot of a source system to be scanned; and
b) detaching a boot volume of the source system and launching a temporary linux instance with a secure shell (ssh) access enabled;
attaching the boot volume of the source system to a temporary linux system;
starting the temporary linux system and mounting the windows disk on the temporary linux system using cloud init; and
booting up the windows machines and running the scanner during windows startup and receiving the functionality comprising the misconfiguration check and the compliance check at an operating system (OS) level.

7. The method of claim 6, wherein launching windows snapshot of source system to be scanned further comprises:
launching the windows snapshot; and
shutting down the instance after the window snapshot is launched.

8. The method of claim 6, wherein detaching the boot volume comprises detaching a disk from the system.

9. The method of claim 6, wherein starting temporary linux system further comprises:
installing a new technology file system (ntfs) driver on the linux system;
installing a chntpw utility;
mounting a new technology file system (ntfs) volume;
injecting a windows service to start on the next launch of the windows instance using a reged command; and
installing a required service binary on the windows disk and configuring a service binary to start the scanner when windows starts up and unmounting the volume.

10. The method of claim 1, wherein scanning of the docker image further comprises:
launching a docker image; and
running the scan operations using docker command for performing a scan task.

11. A system of an agent-less scanning of cloud infrastructure, the system comprising:
a memory for storing one or more executable modules; and
a processor for executing the one or more executable modules for agent-less scanning, the one or more executable modules comprising:
a running module for running a virtual machine (VM) from a customer account and creating a snapshot of the VM in the customer account and saving the snapshot of the virtual machine into a storage account;
a creation module for creating at least one of: a docker image, a virtual machine instance and a bare-metal system by restoring the respective snapshot saved in the storage account and gaining access to a restored system;
a scan module for scanning the restored system by one of: using an ephemeral scanner that runs during a boot time of an instance or using a docker based command on a launched container; and
a termination module for terminating instances of an ephemeral scanner by sending a message to at least one of: a cloud and a plurality of cloud servers for terminating the instances.

12. The system of claim 11, wherein the scan module is further configured for leveraging a cloud init functionality exposed by a plurality of cloud vendors to run an agent-less scanning during the boot time of an instance.

13. The system of claim 11, wherein the scan module is further configured for obtaining a new snapshot to get the latest state of the system scanned during the scan runs.

14. The system of claim 11, wherein the cloud-init functionality allows the scanner to run at boot time with elevated privileges which allows to perform at least one of: misconfiguration or compliance checks at an operating system (OS) level.

15. The system of claim 11, wherein the scan module is further configured for:
preparing a windows system by performing the steps comprising:
a) launching a windows snapshot of a source system to be scanned; and
b) detaching a boot volume of the source system and launching a temporary linux instance with a secure shell (ssh) access enabled.
attaching the boot volume of the source system to the temporary linux system.
starting the temporary linux system and mounting the windows disk on the temporary linux system using cloud init; and
booting up the windows machines and running the scanner during windows startup and receiving the functionality comprising the misconfiguration and compliance checks at an operating system (OS) level.

16. The system of claim 15, wherein the scan module is further configured for:
launching the windows snapshot.
shutting down the instance after the window snapshot is launched; and
detaching a disk from the system.

17. The system of claim 15, wherein the scan module is further configured for:
installing a new technology file system (ntfs) driver on the linux system;
installing a chntpw utility.
mounting a new technology file system (ntfs) volume.
injecting a windows service to start on the next launch of the windows instance using a reged command; and
installing a required service binary on the windows disk and configuring a service binary to start the scanner when windows starts up and unmounting the volume.

18. The system of claim 11, wherein the creation module is further configured for:
launching a docker image; and
running the scan operations using docker command which performs the scan tasks for at least one of: operating system (OS) misconfigurations, software vulnerabilities and malware and ransomware scan.
